(19) United States
(12) Patent Application Publication
(10) Pub. No.: US 2010/0036736 A1
(43) Pub. Date: Feb. 11, 2010

(54) SYSTEM AND METHOD FOR REVENUE SHARING WITH A FITNESS CENTER

(75) Inventors: Ian J. McGee, Sunnyvale, CA (US); Brian Button, Sunnyvale, CA (US); Peter Peterson, Sunnyvale, CA (US); Keith Thompson, Mountain View, CA (US)

Correspondence Address: PERKINS COIE LLP, P.O. BOX 1208, SEATTLE, WA, 98111-1208, US

(73) Assignee: Expresso Fitness Corp., Sunnyvale, CA (US)

(21) Appl. No.: 12/242,644

(22) Filed: Sep. 30, 2008

Related U.S. Application Data
(60) Provisional application No. 61/087,621, filed on Aug. 8, 2008.

(51) Int. Cl. G06Q 30/00; G06Q 40/00; G06Q 20/00; G06Q 90/00

(52) U.S. Cl. 705/14.55; 705/26; 705/40; 705/35; 705/400; 705/1

(57) ABSTRACT

Systems and methods for revenue sharing with a fitness center are disclosed. In one aspect, embodiments of the present disclosure include a method, which may be implemented on a system, to incentivize purchase of internet and/or web-enabled exercise equipment by a fitness center. One embodiment can include, assessing a fee from a user of the internet and/or web-enabled exercise equipment, collecting at least a portion of the fee from the user, and sharing the at least a portion of the fee with the fitness center where the internet and/or web-enabled exercise equipment is physically located.

### CLAIM OF PRIORITY

This application claims priority to U.S. Provisional Patent Application No. 61/087,621 entitled “SYSTEM AND METHOD FOR REVENUE SHARING WITH A FITNESS CENTER”, which was filed on Aug. 8, 2008, the contents of which are expressly incorporated by reference herein.

### BACKGROUND

In most markets, competition amongst equipment manufacturers has created a surplus of competing products lowering retailers' demand to purchase products from any one particular manufacturer in the saturated market. Thus, equipment manufacturers often struggle to motivate retailers to purchase their products and compete with many other fitness equipment manufacturers to gain market share.

Manufacturers have attempted to address this situation several ways. Traditionally, manufacturers have primarily focused efforts on providing fitness centers warrantees on purchased equipment, building prestige based on brand recognition, and providing on-site technical support. However, these techniques for motivating fitness centers to purchase or otherwise acquire (e.g., lease) fitness equipment from a particular manufacturer are common within the market place, easily reproducible, and do not yield consistent, long term, sustainable results.

### BRIEF DESCRIPTION OF THE DRAWINGS

FIG. 1 illustrates a block diagram of a plurality of fitness centers having exercise equipment able to communicate with one another, a plurality of client devices, and a host server that manages content delivery/retrieval and services provided to a user via the exercise equipment, according to one embodiment.

FIG. 2A depicts a flow diagram showing the processes that occur when the host server shares revenue with a fitness center, according to one embodiment.

FIG. 2B depicts a table illustrating an example list of standards to be met for a fitness center to be eligible to share the revenue of the host server, according to one embodiment.

FIG. 3 depicts a diagram showing the interactions that occur between the host server and the fitness center for revenue sharing, according to one embodiment.

FIG. 4 depicts a flow diagram showing the cash flow that occurs between the host server, the fitness center, and users for revenue sharing, according to one embodiment.

FIG. 5 depicts a table illustrating an example list of tiered service levels provided via fitness equipments or by the host server via any internet and/or web-enabled device, according to one embodiment.

FIG. 6A illustrates an example screenshot of a user interface for logging on to a web portal to access exercise-related information, according to one embodiment.

FIG. 6B illustrates an example screenshot of a user interface for creating an account with a username and password to access the web portal for viewing exercise-related information, according to one embodiment.

FIG. 6C illustrates an example screenshot of another user interface for submitting user information for creating the account for the web portal to access exercise-related information, according to one embodiment.

FIG. 6D illustrates an example screenshot of a user interface to select an account type to access the web portal, according to one embodiment.

FIG. 6E illustrates an example screenshot of a user interface to review and finalize information for the newly created account to access the web portal, according to one embodiment.

FIG. 7 illustrates an example screenshot of a home page of the web portal, according to one embodiment.

FIG. 8A illustrates an example screenshot of table showing a user's historical exercise data and fitness information, according to one embodiment.

FIG. 8B illustrates an example screenshot of table showing records of historical exercise data and fitness information for various users, according to one embodiment.

FIG. 8C illustrates an example screenshot of graph showing trends of exercise data and fitness information, according to one embodiment.

FIG. 8D illustrates an example screenshot of a table showing the user's rankings for various exercise environments, according to one embodiment.

FIG. 8E illustrates an example screenshot of a user interface showing a user's fitness achievements, according to one embodiment.

FIG. 8F illustrates an example screenshot of a link to a community forum, according to one embodiment.

FIG. 8G illustrates an example screenshot of a user interface for updating user account information, according to one embodiment.

FIG. 9 depicts a flow diagram illustrating an example process for sharing revenue with a fitness center, according to one embodiment.

FIG. 10A depicts a flow diagram illustrating an example process for sharing revenue with an eligible fitness center, according to one embodiment.

FIG. 10B depicts a flow diagram illustrating an example process for determining eligibility of a fitness center for revenue sharing, according to one embodiment.

FIG. 11A depicts a flow diagram illustrating an example process for providing tiered service levels via an exercise equipment, according to one embodiment.

FIG. 11B depicts a flow diagram illustrating an example process for providing tiered service levels via a internet and/or web-enabled device, according to one embodiment.

FIG. 12 depicts a block diagram of a host server that manages and facilitates revenue sharing with a fitness center, according to one embodiment.

FIG. 13A depicts a block diagram illustrating a repository for storing multimedia content, according to one embodiment.

FIG. 13B depicts a block diagram illustrating a repository for storing user data, according to one embodiment.

FIG. 13C depicts a block diagram of a repository for storing fitness center data, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems and methods for revenue sharing with a fitness center.

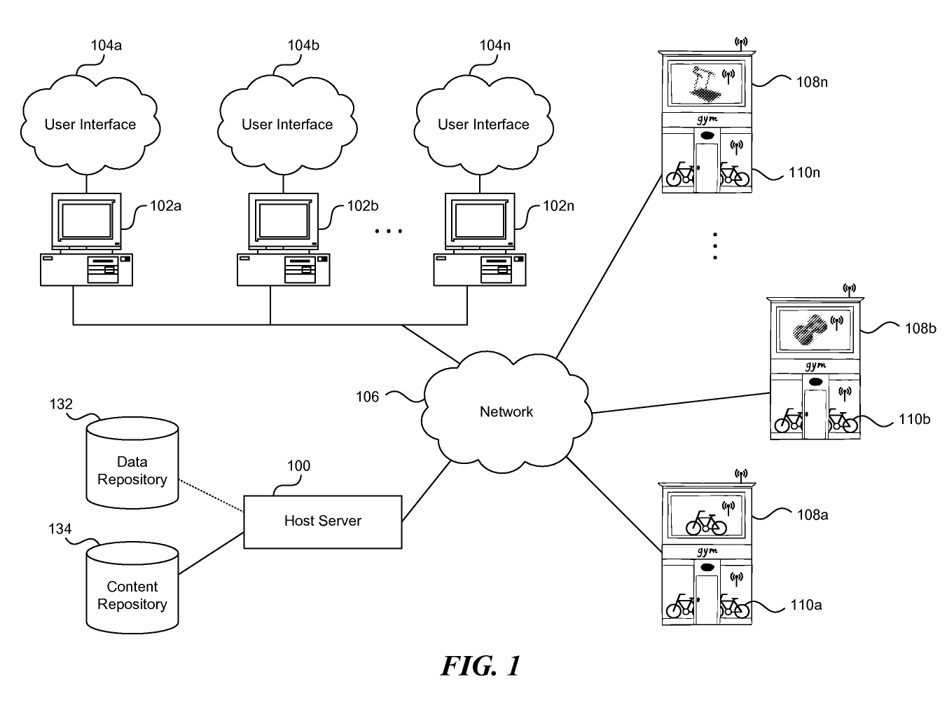

FIG. 1 illustrates a block diagram of a plurality of fitness centers 108A-N having exercise equipment 110A-110N able to communicate with one another, with a plurality of client devices 104A-N, and with a host server 100 that manages content delivery/retrieval and services provided to a user via the exercise equipment, according to one embodiment.

The plurality of client devices 104A-N can be any system and/or device, and/or any combination of devices/systems that is able to establish a networked connection with another device, a server and/or other systems. The client devices 104A-N and exercise equipment 110A-110N typically include display or other output functionalities to present data exchanged between the devices to a user. For example, the client devices 104A-N can be, but are not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the client devices 104A-N and exercise equipment 110A-110N are coupled to a network 106. In some embodiments, the exercise equipment 110A-110N may be directly connected to one another.

The network 106, over which the client devices 104A-N and exercise equipment 110A-110N communicate, may be a telephonic network, an open network, such as the Internet, or a private network, such as an intranet and/or the extranet. For example, the Internet can provide file transfer, remote log in, email, news, RSS, and other services through any known or convenient protocol, such as, but is not limited to the TCP/IP protocol, Open System Interconnections (OSI), FTP, UPnP, iSCSI, NFS, ISDN, PDH, RS-232, SDH, SONET, etc.

The network 106 can be any collection of distinct networks operating wholly or partially in conjunction to provide connectivity to the client devices 104A-N, host server 100, and/or the exercise equipment 110A-110N and may appear as one or more networks to the serviced systems and devices. In one embodiment, communications to and from the client devices 104A-N and exercise equipment 110A-110N can be achieved by, an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more wireless networks, such as, but is not limited to, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The exercise equipment 110A-110N is generally operable internet and/or web-enabled exercise machines that are located in the fitness center 108A-N. Typically, the exercise equipment 110A-110N is one of an eligible-type of exercise equipment that is specified by the host server 100.

The data repository 132 and/or content repository 134 can store software, descriptive data, multimedia, user data, user information, fitness center information, marketing data, revenue data, system information, drivers, and/or any other data item utilized by other components of the host server 100 and/or the exercise equipment 110A-110N for operation. The data repository 132 and content repository 134 may be managed by a database management system (DBMS), for example but not limited to, Oracle, DB2, Microsoft Access, Microsoft SQL Server, PostgreSQL, MySQL, FileMaker, etc.

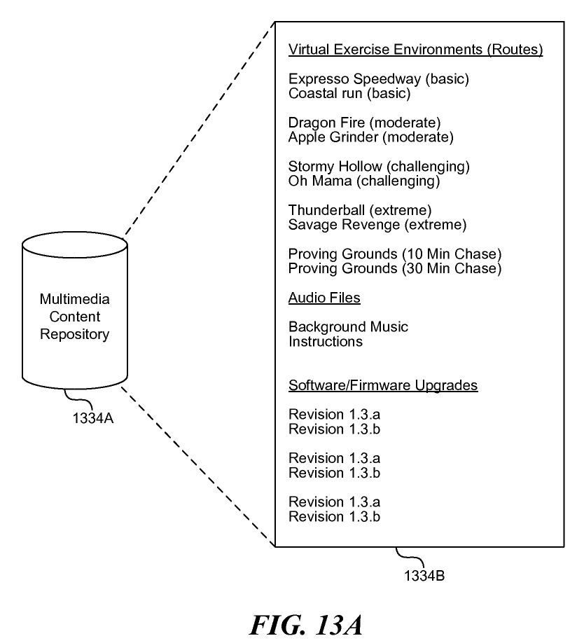

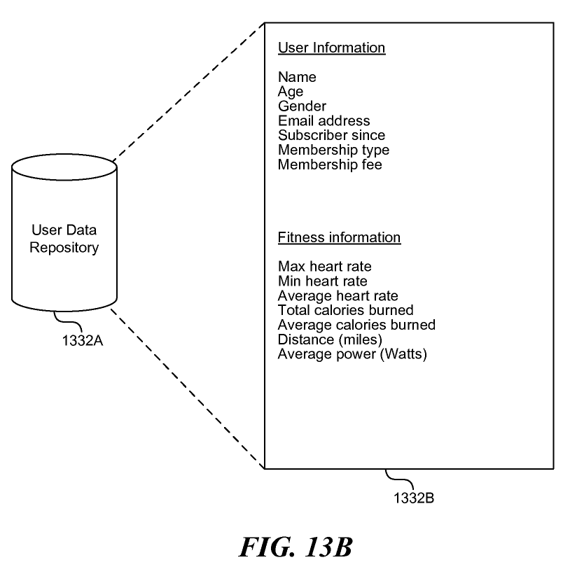

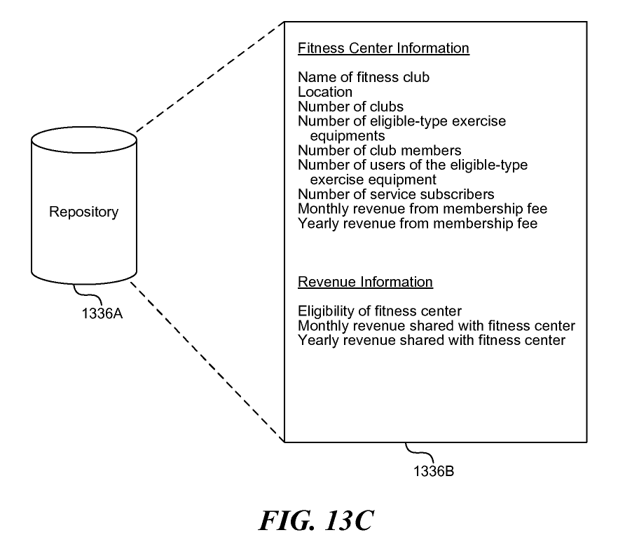

The data repository 132 and/or content repository 134 can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package. Example sets of data to be stored in data repository 132 and/or content repository 134 are illustrated in FIG. 13A-C.

The host server 100 is, in some embodiments, able to communicate with client devices 102A-N and exercise equipment 110A-110N via the network 106. In addition, the host server 100 is able to retrieve data from data repository 132 and/or content repository 134. In some embodiments, the host server 100 is able to assimilate data obtained from the exercise equipment 110A-110N and/or client devices 102A-N to provide enhanced exercising experiences, including but not limited to, various multi-media enhanced exercise environments, general instructions, personalized instructions, personalized workouts, and/or music.

In some embodiments, the host server 100 is further able to assimilate data obtained from the exercise equipment 110A-110N and/or fitness centers 108A-N such that revenue can be shared with the fitness centers 108A-N. The revenue is typically but not necessarily always collected based on membership fees of users of the exercise equipment 110A-100N. for example, membership fees are assessed when the user signs up for certain types of services and/or internet and/or web-enabled features offered by the host 100 and delivered via the exercise equipment 110A-N or via the client devices 102A-N.

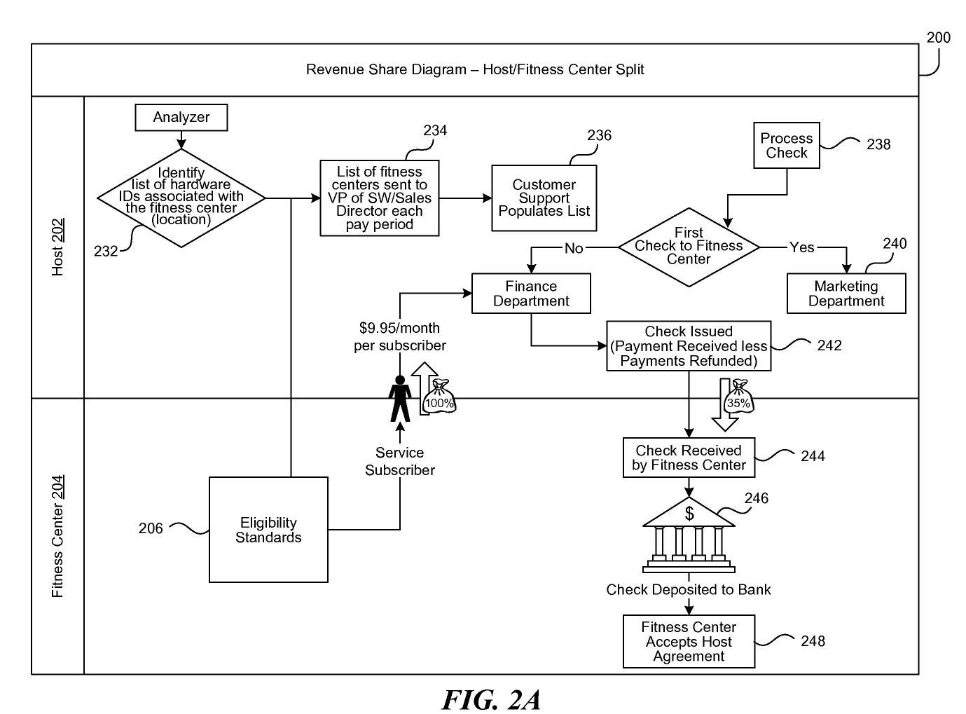

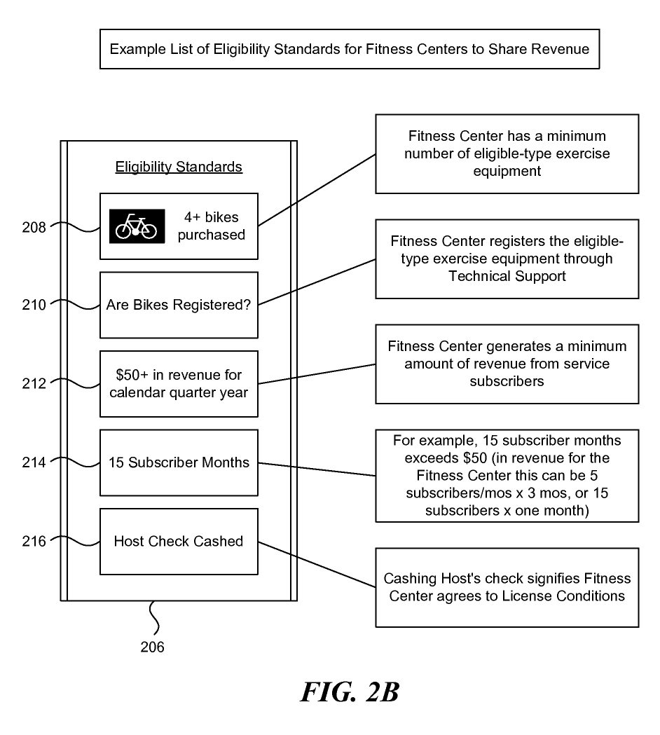

The communications that the host server 100 establishes with the client-end devices can be multi-way and via one or more different protocols. Any number of communications sessions may be established prior to providing multi-media enhanced exercise environments and/or other exercise related services/functions (e.g., web-based features). Each session may involve multiple users communicating via the same or different protocols. The host server 100 communicates with the participating parties or entities (e.g., client devices, fitness centers, exercise equipments, users of exercise equipments, databases, etc.), in series and/or in parallel to obtain the necessary information to perform revenue sharing with the fitness centers and to provide enhanced exercising experiences. The processes of which is described in detail with further references to FIGS. 2-5 and FIGS. 9-11.

In addition, the host server 100 can establish communication sessions with the data repository 132 and/or content repository 134 to identify and store additional information about the users, such as, but not limited to, subscription information, membership information, exercise data, historical fitness data, health-related information, etc.

FIG. 2A depicts a flow diagram 200 showing the processes that occur when the host server 202 shares revenue with a fitness center 204, according to one embodiment.

In one embodiment, the analyzer identifies a list of unique hardware IDs associated with a particular location (e.g., a fitness center), in step 232. The list of unique hardware IDs identify the exercise equipment located at a fitness center. Therefore, users can be associated with fitness centers based on the exercise equipment that they used since users may also be identified by unique identifiers (e.g., username and/or password). Once users (members or subscribers) have been associated with a particular fitness center, a list of fitness centers with which revenue is to be shared can be generated.

In one embodiment, the unique hardware IDs associated with exercise equipment allows remote troubleshooting. For example, knowing the hardware ID of the piece of equipment for which issues have been reported enables test messages to be sent to the equipment to obtain further information about problem. In addition, remote reset of the equipment can be used to address any freeze-up issues or related problems.

In one embodiment, the analyzer optionally determines whether a particular fitness center is eligible for revenue sharing. The eligibility standards are illustrated in 206 and is further described with further reference to FIG. 2B. The eligibility standards are typically specified by the host 202 and may be same or different for different fitness centers or different seasons, etc. The eligibility standards should be subject to change anytime by the host server.

Then, at step 234, a list of fitness centers (e.g., eligible fitness centers) can be compiled each pay period (e.g., each month, each quarter, each year, etc.) and sent for processing and review. For example, the list may be sent to the VP of Software (SW), VP of Sales, and/or the Director of Marketing. Then, in step 236, the list of eligible fitness centers is populated with a contact name and/or a customer address for the fitness centers. This may be performed by customer support center or any other suitable entity. The checks can then be processed in step 238, for example, by the finance department.

In one embodiment, if the check that was processed is the first check that has been sent to a particular fitness center, then the check is provided to the marketing department for distribution in step 240. If this is the second or later check, then the check is provided to the fitness center directly, in step 242. When the check is received by the fitness center in step 244 and cashed in 246, the fitness center thus accepts the service terms and agreements of the host.

FIG. 2B depicts a table 206 illustrating an example list of standards to be met for a fitness center to be eligible to share the revenue of the host, according to one embodiment.

In one embodiment, a predetermined minimum number of exercise equipment of an eligible type physically located in the fitness center is a criterion under which a fitness center is evaluated to determine eligibility. Similarly, variations of such criterion are contemplated and are considered to be within the scope of the novel arts of the disclosure. For example, the criteria could specify a minimum number of exercise equipment of the eligible type that is operable in the fitness center. For example, the criterion could be based on the number of operable equipment located in the fitness center rather then the number of equipment physically located in the fitness center.

Alternatively, the criteria could specify that a minimum number of the eligible type exercise equipment be purchased or leased/rented by the fitness center in a particular period of time. The equipment could be purchased or leased/rented from the manufacturer of the eligible type exercise equipment, a third party, or a combination of both. For example, the criteria may require that the fitness center purchase or lease at least 10 pieces of equipment per year. Note that a combination of any of the above described example criteria could be used in conjunction for the purposes of evaluating eligibility of the fitness center.

In the example of FIG. 2B, the corresponding example criterion specifies that the fitness center should have at least a minimum amount (e.g., four) of the eligible type exercise equipment (e.g., bike) in the facilities.

In one embodiment, registration of the eligible type of exercise equipment with the manufacturer (e.g., host) is a criterion to be satisfied for the fitness center to be eligible for revenue sharing. Registration may allow the host to track usage of the registered equipment and to additionally provide enhanced/customized trouble shooting methods.

In one embodiment, the eligibility is determined by a criterion specifying a minimum amount of revenue generated from the membership fee of the service subscribers. The membership fee is typically assessed from a service subscriber (e.g., a service subscriber is user or operator of the eligible type exercise equipment) to utilize web-features of the eligible-type of exercise equipment physically located in the fitness center. The minimum amount of revenue may vary from club to club and may also vary between clubs located in different geographical locales. For example, clubs with a smaller clientele may be required to generate a lesser amount of revenue. Similarly, a lesser amount of revenue may be expected of clubs located in locales where population is less dense.

In one embodiment, the fitness center is eligible if the amount of revenue exceeds a predetermined value. Alternatively, this criterion can be used in conjunction with one or more of the other above described criteria (e.g., criteria related to the number of eligible-type exercise equipment) to evaluate whether the fitness center is eligible. This criterion encourages the fitness centers to purchase, lease, rent, or otherwise acquire more of the eligible type exercise equipments such that more users may subscribe to the services that assess a membership fee.

In one embodiment, the eligibility is determined based on a criterion specifying a minimum number of subscriber months. A subscriber month is satisfied whenever one user has a one month subscription. Four subscriber months is satisfied whenever one user has a four month subscription or when four users are subscribed for one month. In the example of FIG. 2B, the corresponding example criterion specifies that the fitness center should have at least a minimum (e.g., 15) of subscriber months to be an eligible facility.

In one embodiment, the eligibility is determined based on whether an issued check has been cashed by the fitness center. Since the cashing of the check by the fitness center signifies that the terms and conditions are agreed upon by the fitness center. In some instances, a second check may not be issued or otherwise made available to the fitness center until the first check has been cashed or the fitness center has otherwise indicated agreement to the terms and agreements of the host.

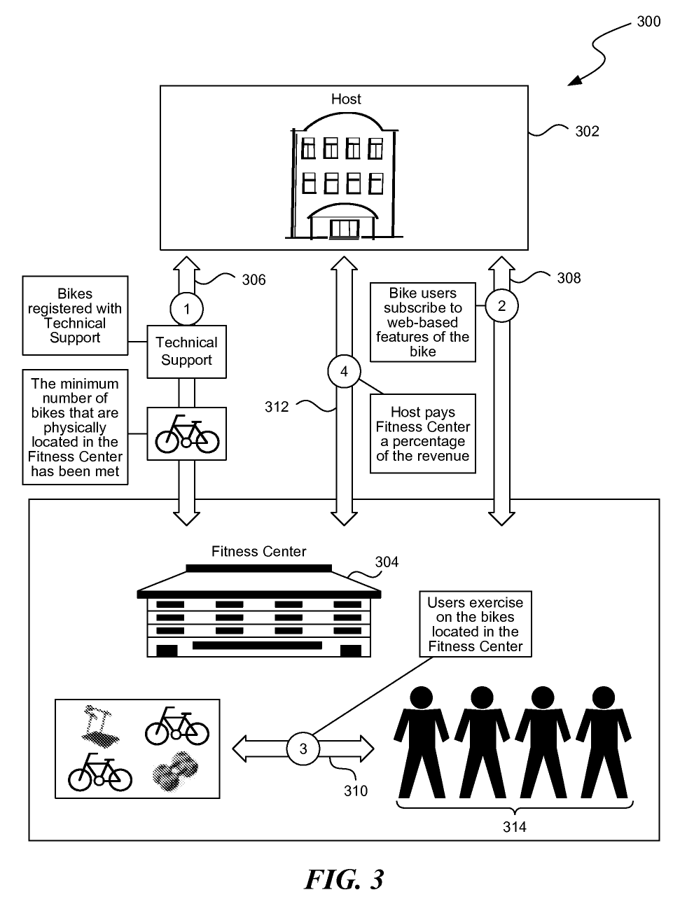

FIG. 3 depicts a diagram 300 showing the interactions that occur between the host 302 and the fitness center 304 in the revenue sharing process, according to one embodiment.

In interaction 306, the eligible type of exercise equipment (e.g., bikes) is registered with the host and that the minimum numbers of bikes for a fitness center to be eligible are determined to be physically located in the fitness center. In interaction 308, bike users subscribe to the web-based features provided by the host (e.g., either accessible via the bike or any other internet and/or web-enabled device). In interaction 310, the bikers use the bikes at the fitness center to exercise. In interaction 312, the host pays the fitness center a percentage of the revenue generated from membership fees assessed from a service subscriber to utilize web-features of an eligible-type of exercise equipment physically located in the fitness center.

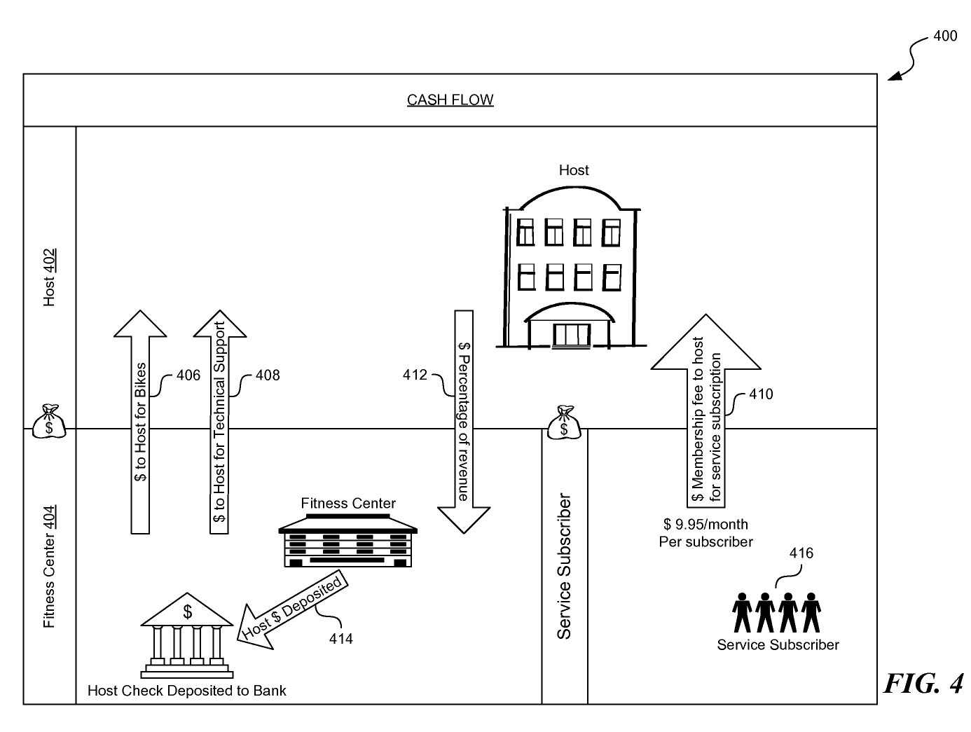

FIG. 4 depicts a flow diagram 400 showing the cash flow that occurs between the host 402, the fitness center 404, and users 416 in the process of revenue sharing with the fitness center 404, according to one embodiment.

In step 406, the fitness facility pays the host to purchase or lease the eligible type of fitness equipments (bikes). In step 408, the fitness facility may optionally pay the host to register the purchased or leased bikes for technical support. In step 410, the users 416 become service subscribers of the web-features provided and offered by the host (or in some instances, a third party) by paying a membership fee. In step 412, the host in turn pays the fitness center a percentage of the revenue generated from membership fee collected from service subscribers who use the bikes in the fitness center. Although the example herein provided is directed towards interacting with the host, it is noted that the transactions can occur between the fitness center and a third party to purchase/lease bikes or to receive internet and/or web-enabled services. For example, some or all of the web-features may be provided by a third party, and delivered to end users via a third party.

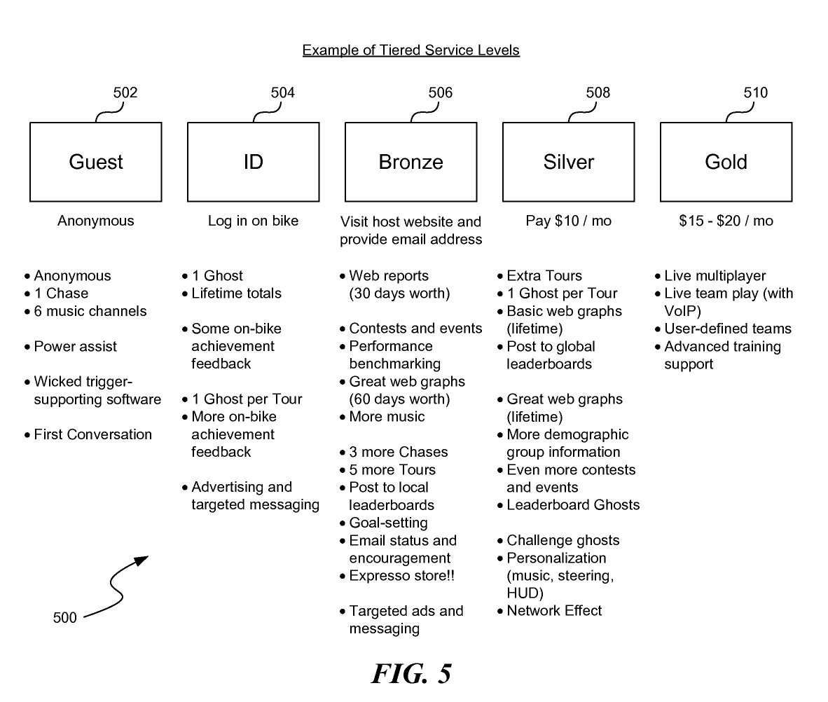

FIG. 5 depicts a table 500 illustrating an example list of tiered service levels provided via fitness equipments or by the host server via any internet and/or web-enabled device, according to one embodiment.

In general, the tiered service levels differ in the number and type of services/features accessible by a user (e.g., operator or exerciser), for example, via the exercise equipment (e.g., an eligible type of exercise equipment) and/or any internet and/or web-enabled device. In one embodiment, different web-based features are provided to a subscribing user via the eligible-type of exercise equipment based on the tiered service level that the service subscriber has enrolled in. The services/features may be provided during the time of exercise or at a later time and is generally configurable and/or selectable by the user. The tiered service levels offer different users of various usage levels a suitable set of services. The services/features may be provided, offered, developed by the host (e.g., maker/manufacturer of the exercise equipment), a third party, or a combination of the above.

As an example, features provided directly via exercise equipment include offering additional exercise environments (e.g., virtual exercise routes) to a user. In addition, chases, ghost riders (e.g., another biker provided in the virtual exercise route), audio, multi-player environment or team racing environment provided in real time or near real-time. The riding characteristics of a ghost rider may be based on historical exercise data of the user or may be based on another user exercising in the same virtual exercise route. The features delivered via the exercise equipment are generally multimedia enhanced (e.g., 2D, 3D, video, animation, audio, and/or text, etc.) and in some instances are VoIP-enabled.

Furthermore, feedback regarding exercise performance may also be provided during or after exercise via the exercise equipment. Personalized messages and exercise instructions may similarly be delivered before, during, and/or after a particular exercise session.

Features and services provided or delivered via any internet and/or web-enabled interface can include by way of example but not limitation, unique user identification, tracking of exercise and/or fitness data, providing progress reports (e.g., web-based) over a predetermined period of time (e.g., a day, a week, a month, two months, etc.). Progress reports may be provided in graphical or tabular format, for example. In addition, demographic information related fitness data for a group of users could be compiled and provided as reference to users.

In the example table 500 of FIG. 5, the tiered service levels include a guest level 502, an ID level 504, a bronze level 506, a silver level 508, and a gold level 510. In the guest level 502, the user remains anonymous and receives a default set of features. The features provided via the exercise equipment (e.g., network-enabled exercise equipment) generally include a default set of features including multimedia content enhanced exercise environments. For example, the guest user receives access to 34 exercise environments (tours), 1 chase, and 6 music channels. Additional features are listed with further reference to table 500.

In the ID level 504, in response to determining identification of a user (operator) of the network-enabled exercise equipment (e.g., via username/password or any other unique identifier), customized set of features can then be provided to the identified user. In one embodiment, the customized set of features includes, operator-specific performance feedback. The operator-specific performance feedback may be delivered via the network-enabled exercise equipment Additional features provided upon identifying the user includes messaging such as operator-specific messaging. Similarly, targeted advertising may be provided to identified users.

In one embodiment, additional ghost riders are available via the exercise equipment after having identified the user. Additional features are listed with further reference to table 500.

In the bronze level 506, the user (e.g., operator of the network-enabled exercise equipment) is able to receive web-based exercise-related information (e.g., via email, via messaging, via logging on to a website, etc.). In one embodiment, in response to receiving a request from the user to receive web-based exercise-related information, requesting the operator for an email address to which correspondences are to be sent. The user can submit the email address via a web-site or via the exercise equipment. The email address for the operator can be stored and the web-based exercise-related information for the operator can be sent to the email address. The web-based exercise-related information can include a report (e.g., web-report) of exercise data generated by the operator over a predetermined time period (e.g., a week, a month, etc.).

Furthermore, opportunities to participate in contests and events can be presented to users either via the exercise equipment, email, or other web-based means. Global performance and achievement for various exercise routes and be viewed or otherwise accessed via any internet and/or web-enabled device (e.g., any internet and/or web-enabled device able to log on to a web-site). Additional features are listed with further reference to table 500.

In the silver level 508, additional sets of multi-media enhanced features can be provided to the user. For example, additional exercise environments and/or audio files (e.g., music or instructions) can be provided. In addition, web-accessible reports (e.g., tables or graphs) of exercise data and/or fitness information compiled for the user over a predetermined period of time may be provided. Global data may be compiled and provided to the user for reference in comparison with performance. In one embodiment, the silver level 508 assesses a membership fee (e.g., $10/month) from the user to receive the services and to access the features offered by this service level. Additional features are listed with further reference to table 500.

In the gold service level 510, a multi-player exercise session provided in real-time or near real-time. Users can participate in team-based exercise sessions wherein the teams are user-specifiable. In one embodiment, advanced training support is available. In one embodiment, the silver level 508 assesses a membership fee (e.g., $15-20/month) from the user to receive the services and to access the features offered by this service level.

In one embodiment, each service level includes all of the services, functions, and/or features available in all previous (or lower) service level tiers.

Note further that many services, functions, and/or features that are offered are not necessarily tied to any of the service levels or membership thereof. For example, users can participate in live contests directly from the equipment (e.g., fitness-center wide contests, local contest, and/or global contest). In one embodiment, the user is able to join a race or contest at the click of a button (physical or on-screen) on the equipment. This is generally enabled when the user has previously provided the host (service provider) with billing information (e.g., credit card, checking account #, etc.) such that the user can be automatically charged. The user is also usually identified by a unique identifier (e.g., username and/or password combination) allowing the request to be associated with billing information.

Users can also participate in games/tournaments where ammunition (or other digital objects) is needed to target goblins or other bikers in the game. In one embodiment, the digital objects such as ammunition can be purchased or otherwise acquired at the click of a button on the equipment while the user is exercising. One embodiment includes, receiving a request to receive access to a feature via a networked exercise equipment, the request to be received based on an action performed by an operator of the networked exercise equipment, identifying user information associated with the operator, the user information comprising billing information, providing access to the feature via the networked exercise equipment, and billing the operator for the feature using the billing information. The action performed by the operator comprises may include a click of a button on the networked exercise equipment. In general, the request can be received in real-time or near real-time by a server at a location remote from the networked exercise equipment.

In some embodiments, sites and/or bike licenses are available to owner entities (e.g., fitness centers, clubs, gyms, school gyms, etc.). These sites and/or bike licenses can allow certain predetermined service levels to be accessible by the exercise equipment. For example, the licenses may treat everyone who uses the equipment as a member of a higher tiered service level than they would otherwise be entitled to. The licenses may allow users to access a subset of the tiered service levels that are offered.

For example, a high school gym equipped with the exercise equipment can use (acquire or purchase) the sites/bike licenses to treat every user as a silver member such that the students are not asked to pay for more features and/or service.

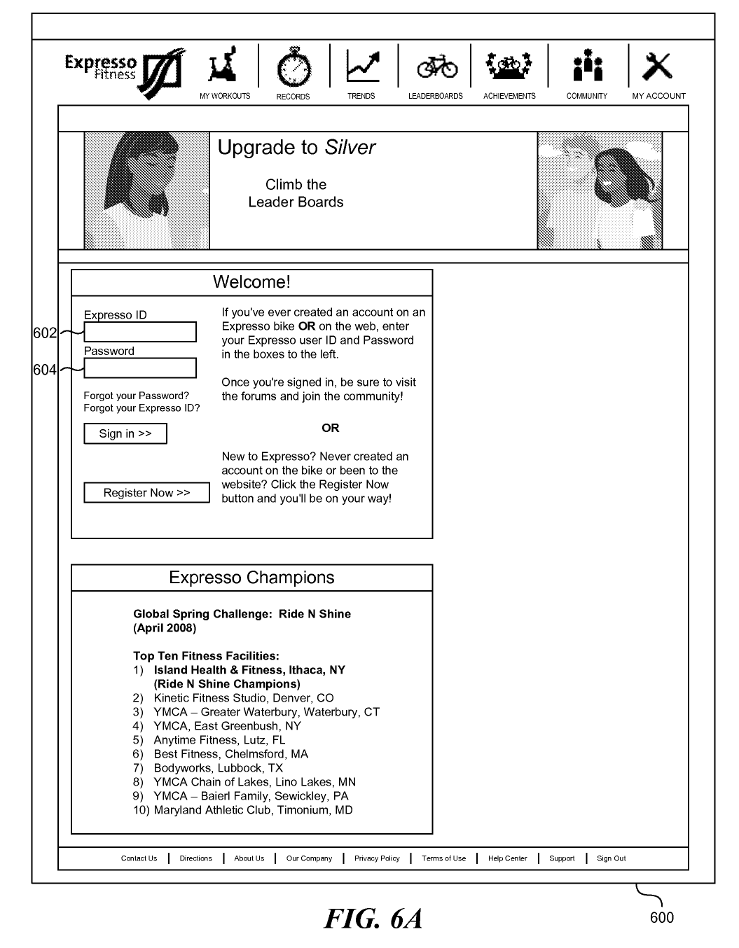

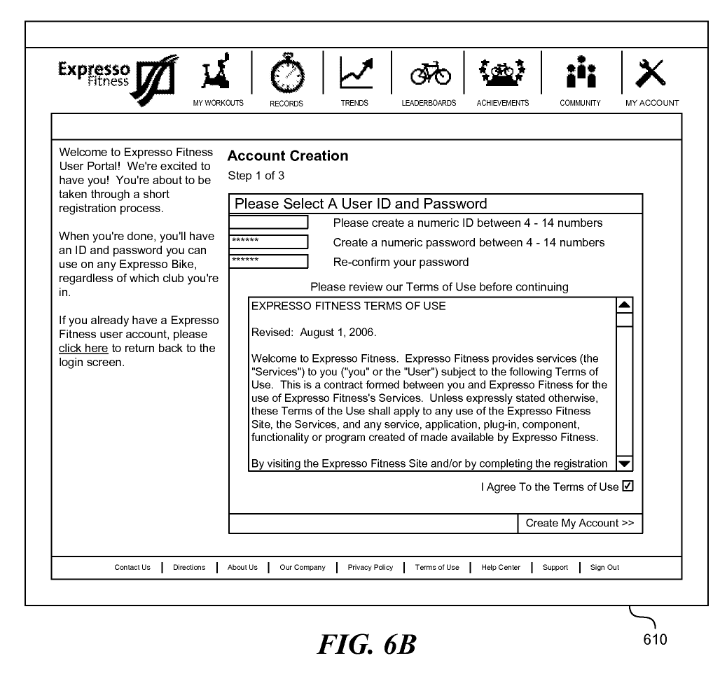

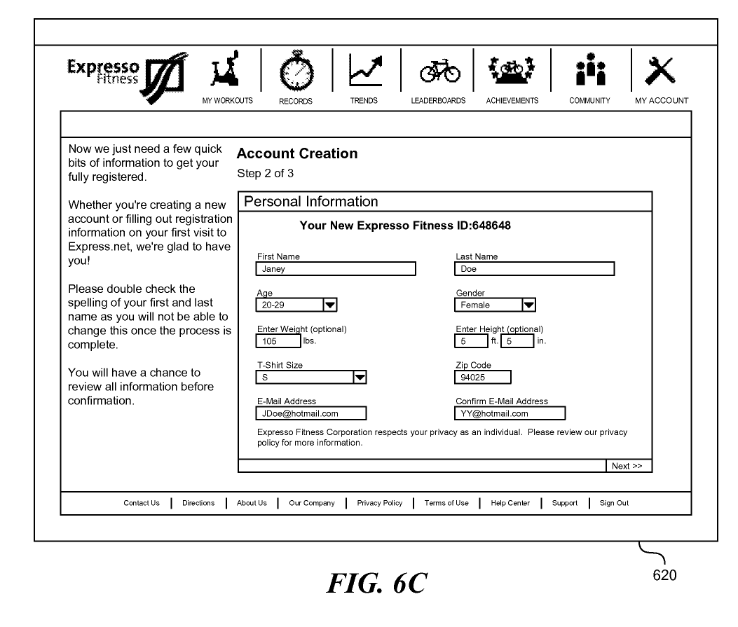

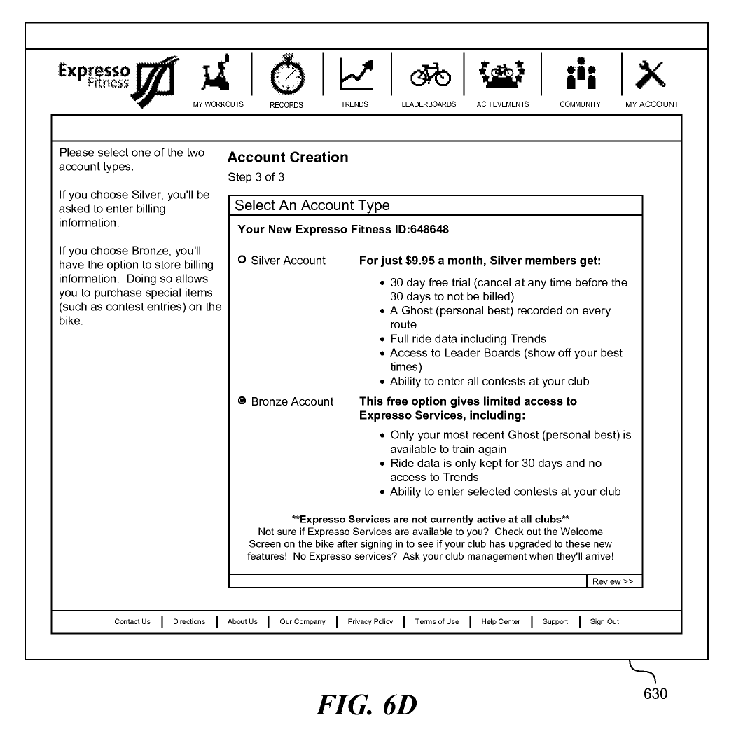

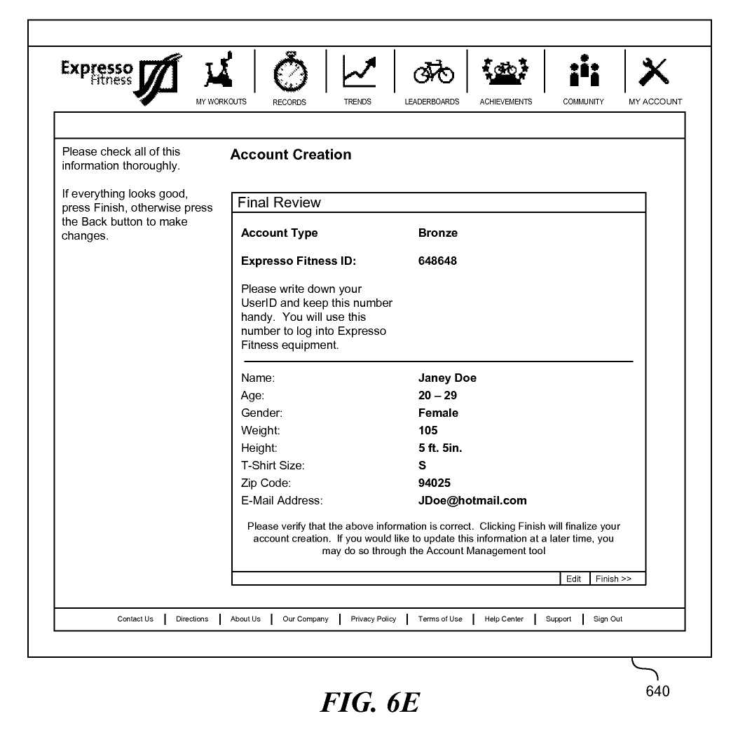

FIG. 6A illustrates an example screenshot of a user interface 600 for logging on to a web portal to access exercise-related information, according to one embodiment.

In one embodiment, a user of exercise equipment is uniquely identified by an ID 602 and password 604. This ID/password combination can also be submitted via the exercise equipment when exercising such that user-specific exercise data and fitness information can be logged accordingly and viewed when the user logs on via a webpage. In some embodiments, other methods of uniquely identifying a user can be used.

FIG. 6B illustrates an example screenshot of a user interface 610 for creating an account with a username and password to access the web portal for viewing exercise-related information, according to one embodiment.

Existing or new users of the exercise equipment can register for an online account via the website by selecting a user ID and password to access exercise data and/or other fitness or exercise-related information. FIG. 6C illustrates an example screenshot of another user interface 620 for submitting user information for creating the account for the web portal to access exercise-related information, according to one embodiment. The user can provide general information including but not limited to, name, age, gender, weight, height, geographical location, contact information, etc. that they wish to be associated with their account. The submitted gender, age, weight, and/or height information can be used to determine fitness data of the user. In addition, demographic specific fitness data can be compiled and provided to users who wish to reference statistical fitness-related data for a particular demographic.

FIG. 6D illustrates an example screenshot of a user interface 630 to select an account type to access the web portal, according to one embodiment.

The availability of account types enables users to sign up for one of the tiered service levels such as the example service levels shown in the table of FIG. 5.

Two service levels (e.g., silver and bronze) are shown in this example for the purposes of illustration. The bronze account is currently free of charge and allows users to view 30 days of exercising data (e.g., ride data) without access to trends (e.g., plots and graphs) of the exercise/fitness data. The silver account current charges a fee (e.g., $9.95/month) and allows users access the full exercise data and trends. Additionally, leader boards are also accessible to members with a silver account. Any number of services levels can be offered with or without a fee. These variations are contemplated and are considered to be within the novel art of the disclosure.

FIG. 6E illustrates an example screenshot of a user interface 640 to review and finalize information for the newly created account to access the web portal, according to one embodiment. Account information may be edited or confirmed at this process by clicking the ‘edit’ button or the ‘finish’ button. Once the ‘finish’ button is clicked, the user has completed the registration process via submitting the relevant information and the online account can then be created.

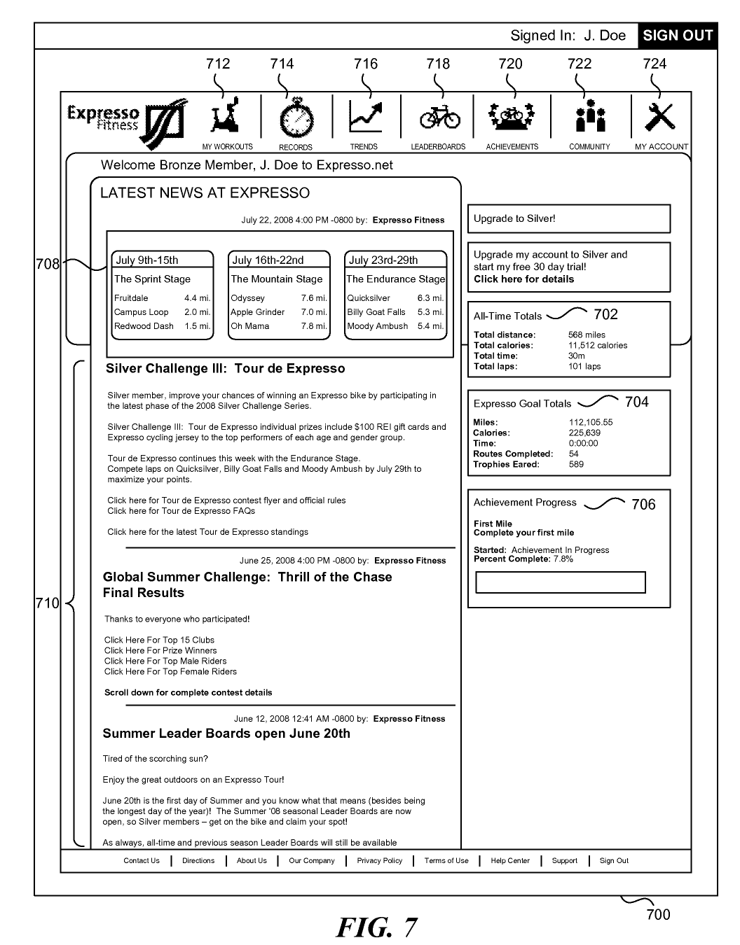

FIG. 7 illustrates an example screenshot of a home page 700 of the web portal, according to one embodiment.

The home page 700, in one embodiment, shows statistical exercise data of the logged on user and of global users. For example, the home page illustrates the cumulative exercise data 702 of the logged on user and the cumulative exercise data 704 of all users. The cumulative data can include, the total distance (e.g., in miles), total calories, the total amount of time, and the total number of laps. The total number of routes completed and trophies earned for all users are also in one embodiment, tracked and available for viewing or access. The user's achievement progress 706 may also be displayed on the home page.

A table 708 showing the availability of new exercise environments (e.g., routes) can, in one embodiment, be displayed. For example, the name of the exercise environment and the distance of the route are shown on the home page 700.

In addition, an announcement board 710 can be used for publishing miscellaneous information, including, announcing new features, availability of contests, events, or results of contest, etc.

The home page 700 can display multiple icons that provide links to additional information related to exercise and fitness. For example, the user can access workout data via the ‘My Workouts’ icon 712, records via the ‘Records’ icon 714, trends (e.g., tables and/or graphs) via the ‘Trends’ icon 716. Additionally, global information such as statistical data related to different exercise routes can be published and accessed via the ‘Leaderboards’ icon 718. The ‘Achievements’ icon 720 allows users to view milestones or other achievements. The ‘Community’ icon 722 links the user to an online discussion forum where users can share experiences on the exercise equipments and/or provide feedback for the service and equipment.

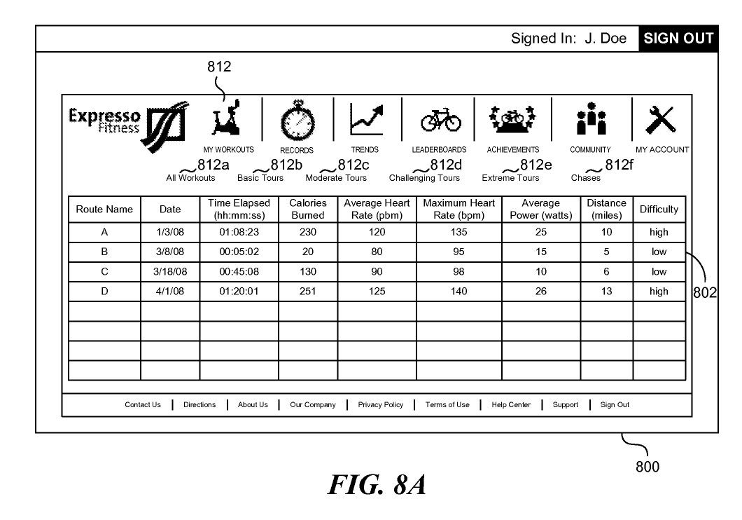

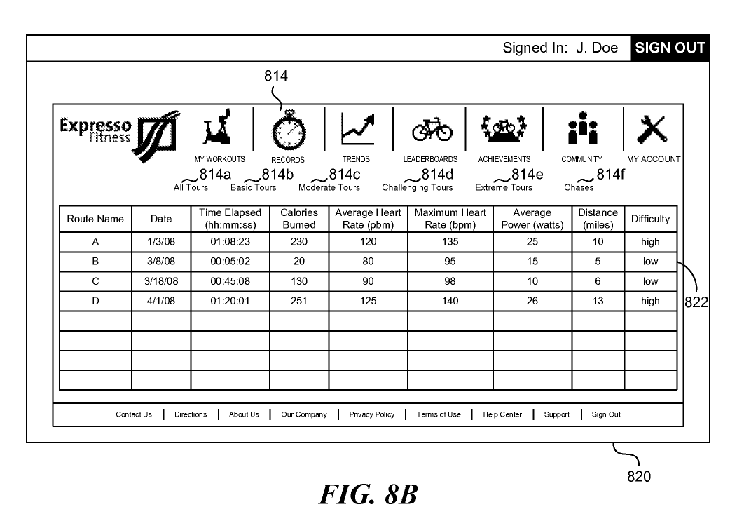

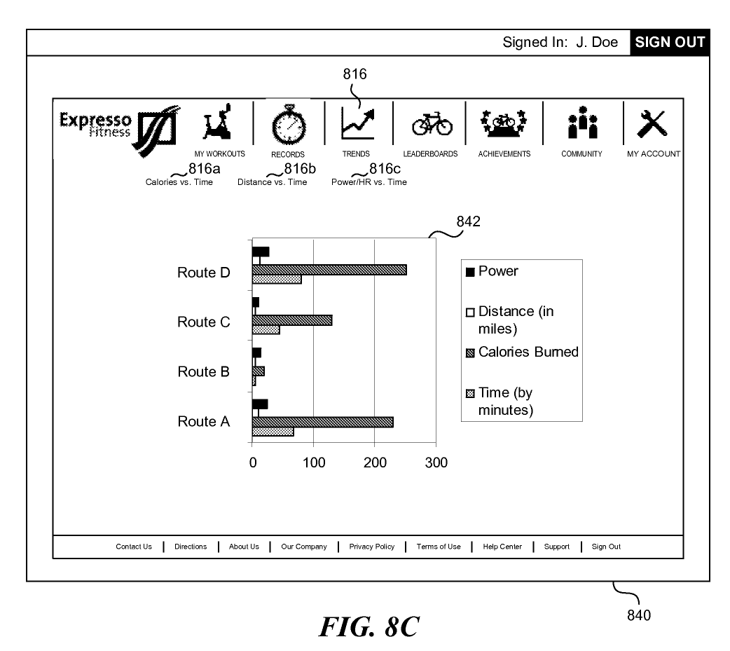

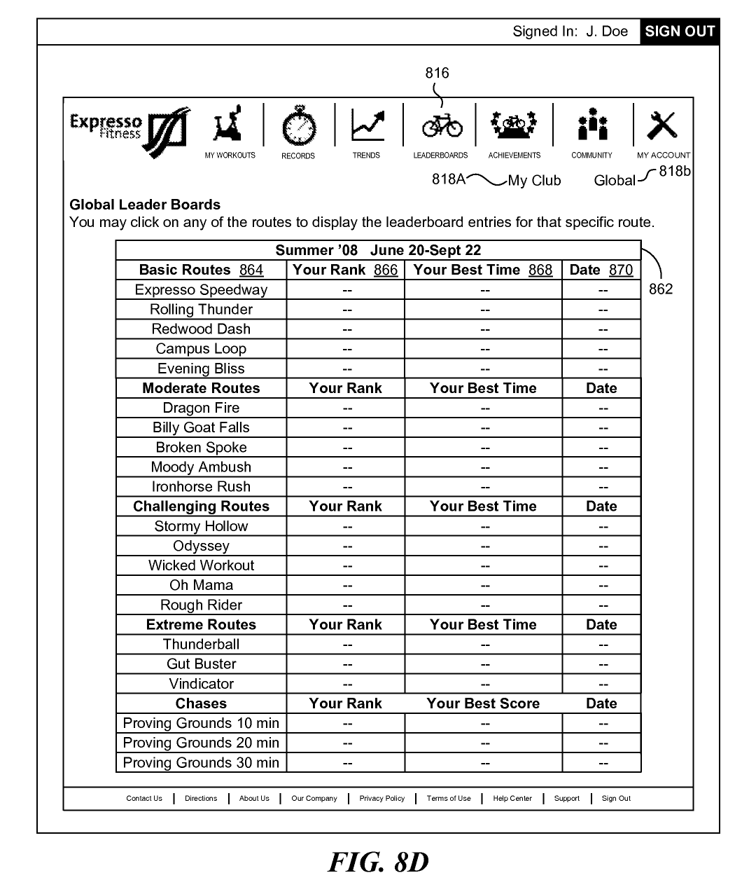

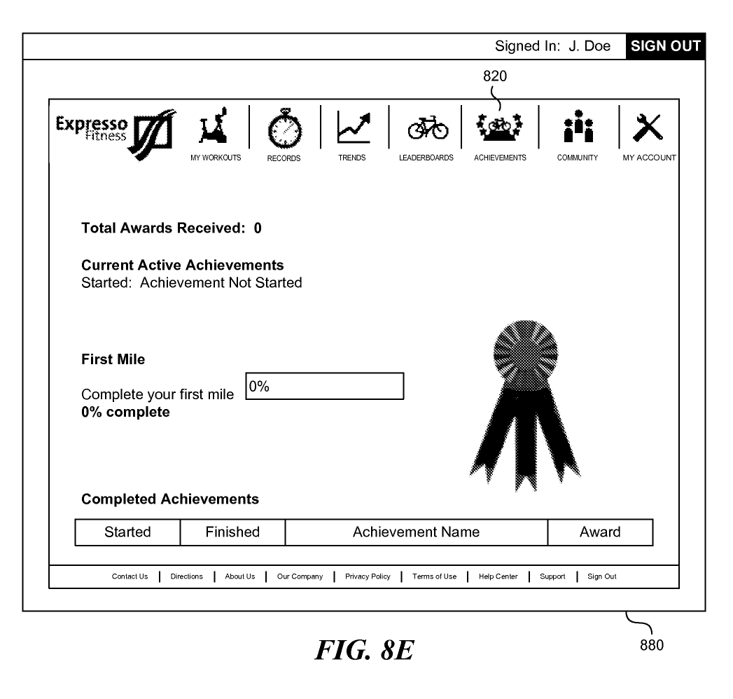

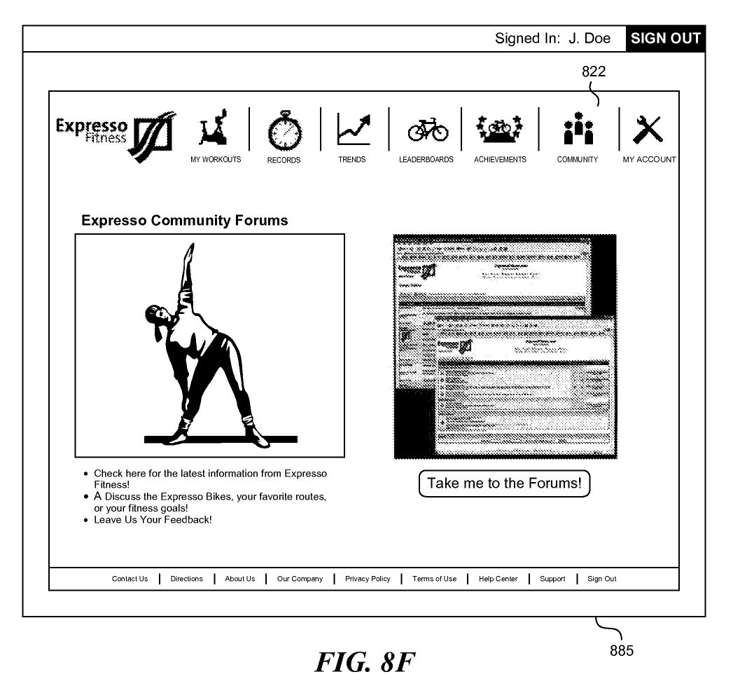

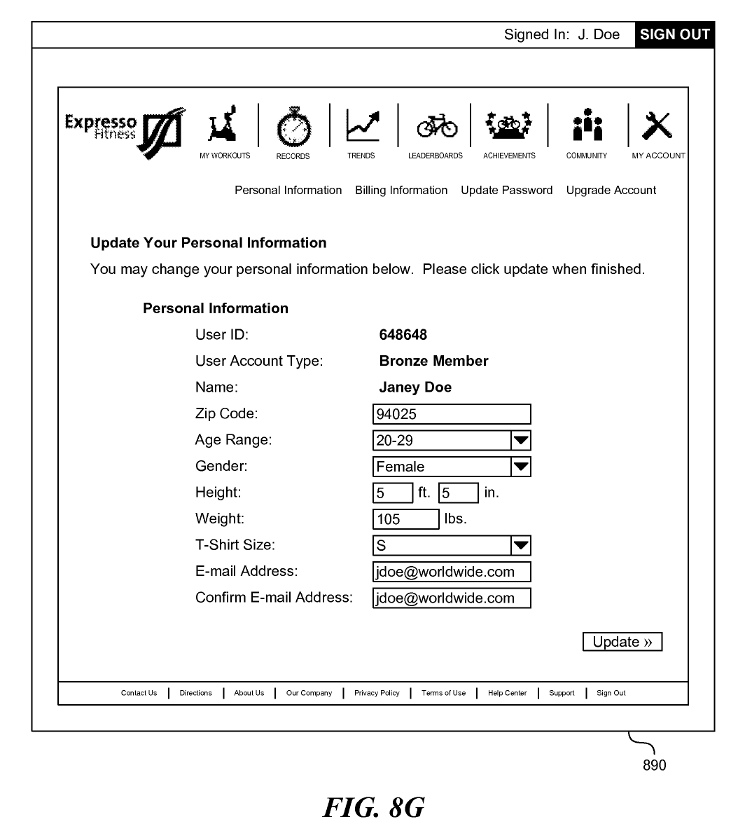

FIG. 8A illustrates an example screenshot of table 802 showing a user's historical exercise data and fitness information, according to one embodiment.

The user can select to view the exercise data/fitness information for all workouts 812A, the basic tours 812B, moderate tours 812C, challenging tours 812D, extreme tours 812E, or chases 812F.

In one embodiment, the table 802 includes route-specific exercise data. For each route that the user has biked through, the table 802 can illustrate one or more of the date, the total time that the user was biking, the calories burned, the average heart rate (BPM), the maximum heart rate (BPM), the average power (watts), the distance biked (miles), and/or the difficulty of the route. Similarly, FIG. 8B illustrates an example screenshot of table 822 showing records of historical exercise data and fitness information for various users, according to one embodiment. The user can select to view the records for all tours 814A, the basic tours 814B, moderate tours 814C, challenging tours 814D, extreme tours 814E, or chases 814F. In one embodiment, the table 822 includes route-specific exercise data. For each route, the table 822 can illustrate one or more of the date, the total time that the user was biking, the calories burned, the average heard rate (BPM), the maximum heart rate (BPM), the average power (watts), the distance biked (miles), and/or the difficulty of the route.

FIG. 8C illustrates an example screenshot of a graph 842 showing trends of exercise data and fitness information, according to one embodiment.

The user can select to review exercise trends via charted exercise data/fitness information for various metrics including but not limited to, calories 816A, distance 816B, and/or for power 816C. In the example graph 842 of FIG. 8C, the selected metric is plotted versus time. The user is generally able to select the time period (e.g., over a week, over a month, over two months, etc.) for which the selected metric is plotted. Additionally, each data point can be generated from exercise over any amount of time. For example, in the example chart 842, each data point is generated per day. Alternatively, data can be generated for each exercise session or over a multi-day period.

FIG. 8D illustrates an example screenshot of a table 862 of a global leader board showing the user's rankings for various exercise environments, according to one embodiment.

In the example of FIG. 8D, the leader board can be generated for the club that the user belongs to (select ‘My Club’ icon 818A) or for all users (select ‘Global’ icon 818B). The table 862 can include, for each route shown in column 864, the user's overall rank in column 866, the user's best time in column 868, and/or the date that the best time was attained in column 870. Since users can bike in the same routes multiple times, the table is generally continuously updated based on newly attained records.

FIG. 8E illustrates an example screenshot of a user interface 880 showing a user's fitness achievements, according to one embodiment.

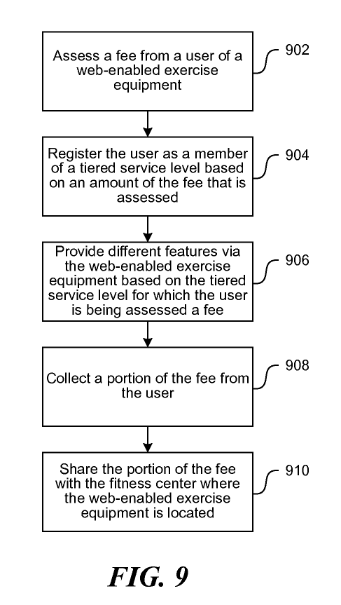

The user's fitness achievements can be illustrated in one or more of many ways. For example, the achievements page illustrates the number of awards the user has received and the % to completion of the first mile. A detailed list of the user's achievements may further be provided specifying when the user began and finished a particular route, the name of the achievement and the award. Additional metrics of achievements are contemplated and are considered to be within the scope of this disclosure. FIG. 8F illustrates an example screenshot 885 of a link to a community forum, according to one embodiment. FIG. 8G illustrates an example screenshot of a user interface 890 for updating user account information, according to one embodiment. FIG. 9 depicts a flow diagram illustrating an example process for incentivizing purchase of internet and/or web-enabled exercise equipment by a fitness center, according to one embodiment.

In process 902, a fee is assessed from a user of the internet and/or web-enabled exercise equipment. In one embodiment, the fee assessment is generally associated with registering the user as a member of a tiered service level. In some embodiments, a fee can be assessed from the user for any services rendered and/or products used/purchased that is related to usage or functional enhancement of the internet and/or web-enabled exercise equipment. The tiered service level of which the user wishes to be a member of determines the amount of fee that is assessed. For example, different features are provided via the internet and/or web-enabled exercise equipment based on the tiered service level for which the user is being assessed a fee. In some embodiments, additional or alternative features are provided and/or accessible via any internet and/or web-enabled device.

In process 904, the user is registered as a member of a tiered service level based on the amount that is assessed. In process 906, different features are provided via the internet and/or web-enabled exercise equipment based on the tiered service level for which the user is being assessed a fee. In some embodiments, the features and services are delivered via email or via a website that members can log on to. An example list of tiered service levels and an example of the types of services that are offered is illustrated with further reference to FIG. 5.

In process 908, at least a portion of the fee is collected from the user. The fee can be collected via any known and/or convenient manner. For example, a payment method may be requested from the user via the web-based exercise equipment or another internet and/or web-enabled device. The user may be charged immediately upon agreement to sign up for membership. Alternatively, the user may be offered a trial membership for a period of time after which the user will be charged unless membership is terminated.

In process 910, a portion of the fee is shared with the fitness center where the internet and/or web-enabled exercise equipment is located. In one embodiment, the internet and/or web-enabled exercise equipment is associated with a unique hardware ID. The unique hardware ID can be used to determine the location (e.g., which fitness center) of the exercise equipment. This can be achieved in one or more of many ways. For example, the fitness center can register the equipment located on the premises. In addition, the IDs of the equipment can be associated with the fitness center during time of purchase or transaction.

Since users can logon to the exercise equipment before, during, and/or after using the equipment, the equipment with which the user is exercising on can be identified. By identifying the location of the exercise equipment, the location at which the user is exercising can be determined, for example, for the purposes of revenue sharing with fitness centers.

The fitness center may be purchased, leased, or obtained the exercise equipment via any other means. The fee collected from the users of the internet and/or web-enabled exercise equipment at the fitness center helps to generate revenue. Thus, by sharing a portion of the fees collected for user membership with fitness centers, the fitness centers are motivated to purchase the internet and/or web-enabled exercise equipment as opposed to other types of exercise equipment.

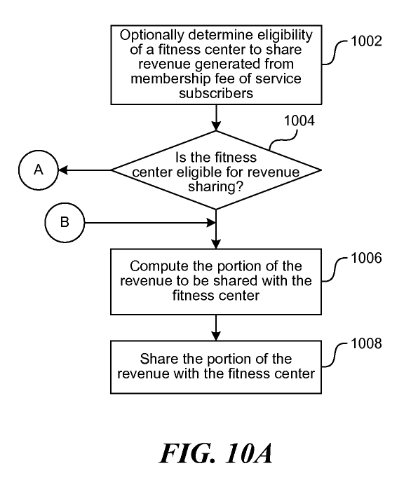

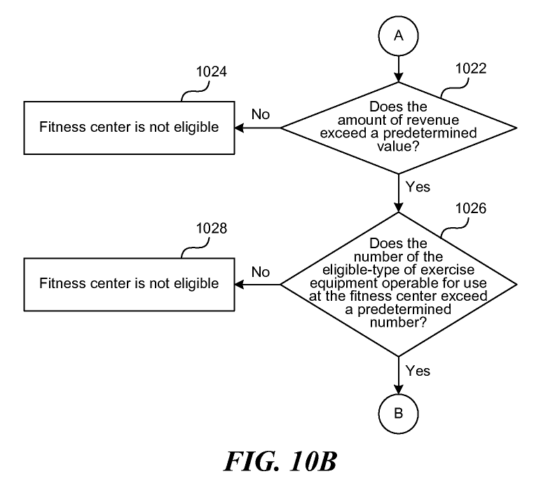

FIG. 10A depicts a flow diagram illustrating an example process for sharing revenue with a fitness center, according to one embodiment.

In process 1002, eligibility of a fitness center to share revenue generated from membership fee of service subscribers is optionally determined. Although in some embodiments, only eligible fitness centers are eligible for revenue sharing, it is contemplated that in some implementations, most if not all fitness centers with service subscribers are considered to be eligible, and is considered to be within the scope of the disclosure.

The membership fee is typically assessed from a service subscriber to utilize web-features of an eligible-type of exercise equipment that is physically located in the fitness center. In the situation where a service subscriber exercises on the eligible-type of exercise equipment at more than one club locations, the revenue can be shared with each or some of the club locations. Alternatively, the revenue is only shared with the fitness center at which the subscriber last exercised that pay period (e.g., that month).

In process 1004, is it determined whether the fitness center is eligible for revenue sharing. In one embodiment, the eligibility is determined by an amount of revenue generated from the membership fee of the plurality of service subscribers. For example, the fitness center may be eligible if the amount of revenue exceeds a predetermined value. In one embodiment, the eligibility is determined by a number of the eligible-type of exercise equipment operable for use at the fitness center. For example, the fitness center is eligible if the number of the eligible-type of exercise equipment exceeds a predetermined number. An example process for verifying the eligibility of a fitness center is illustrated with further reference to FIG. 10B.

In process 1006, if the eligibility of the fitness center is verified, a portion of the revenue to be shared with the fitness center is computed. In one embodiment, the portion of the revenue to be shared with the fitness center is a predetermined percentage of the revenue. For example, the revenue is generally determined in part based on collected portion of the membership fee assessed from the service subscribers. In process 1008, the portion of the revenue is shared with the fitness center. The revenue can be shared via mailing a check to the fitness center, direct deposit, and/or any other known/convenient means.

FIG. 10B depicts a flow diagram illustrating an example process for determining eligibility of a fitness center for revenue sharing, according to one embodiment.

In process 1022, it is determined whether the revenue amount exceeds a predetermined value. If not, in process 1024, the fitness center is determined to be ineligible for revenue sharing. Generally, the revenue is at least in part generated from membership fee assessed or collected from service subscribers. In some embodiments, the revenue used to determine eligibility can include collections from sources in addition to membership fees.

In process 1026, it is determined if the number of the eligible-type of exercise equipment operable for use at the fitness center exceed a predetermined number. If not, in process 1028, the fitness center is determined to be ineligible for revenue sharing.

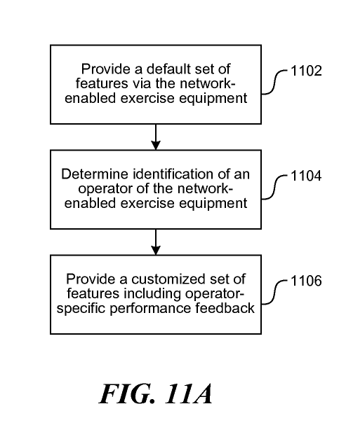

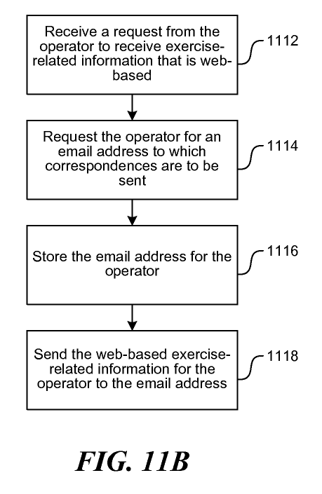

FIG. 11A depicts a flow diagram illustrating an example process for providing tiered service levels via an exercise equipment, according to one embodiment.

In process 1102, a default set of features are provided via the network-enabled exercise equipment. In one embodiment, the default set of features includes multimedia content enhanced exercise environments.

In process 1104, identification of an operator (a user) of the network-enabled exercise equipment is determined. In one embodiment, the identification of the operator is based on verifying an identifier submitted via the network-enabled exercise equipment. For example, the identifier includes a unique username and password combination for the operator. In some embodiments, alternate forms of identification may be used including are but not limited to, biometric identifiers and/or voice recognition.

In process 1106, a customized set of features including operator-specific performance feedback is provided in response to identifying the user. The operator-specific performance feedback is delivered via the network-enabled exercise equipment or via any internet and/or web-enabled device. For example, performance feedback can include historical performance data (e.g., track record, number of miles biked) or fitness data (e.g., heart rate, calories burned, etc.) delivered via a visible medium and/or an audible medium.

In one embodiment, the customized set of features further includes operator-specific messaging and/or targeted advertising. For example, since the operator can be uniquely identified, operator-specific messages can be delivered to the operator during, before, or after an exercise session. For example, operator-specific messages can include exercise tips, fitness tips, and/or instructions/recommendations during a work-out session. Additionally, since exercise and fitness data is recorded for a particular operator, this information can be used to build a fitness profiles for various operators. In some instances, fitness profiles can be used to provide targeted advertising. For example, third-party advertisers may wish to utilize the fitness profiles to better target potential customers. In one embodiment, the fitness profiles are compared to a set of advertisements by the host or the advertisement provider to identify the users towards whom the ads can be optimally targeted.

FIG. 11B depicts a flow diagram illustrating an example process for providing tiered service levels via a internet and/or web-enabled device, according to one embodiment.

In process 1112, a request from the operator to receive exercise-related information that is web-based is received. In one embodiment, the web-based exercise-related information includes a report of exercise data generated by the operator over a predetermined time period. In general, the request is associated with receiving a membership request for a particular service level for which a membership fee can be assessed. For the purposes of description, this service level is referred to as the ‘first-tier service level’. In one embodiment, an additional set of multi-media enhanced features is provided to members of the first-tier service level.

In process 1114, the operator is requested for an email address to which correspondences are to be sent. The operator may be requested over a user interface of the network-enabled exercise equipment or via Internet access on any other internet and/or web-enabled device. Once the email address has been received, in process 1116, the email address is stored for the operator. In process 1118, the web-based exercise-related information for the operator is sent to the email address.

Similarly, a second-tier rate can be assessed for membership in a second-tier service level. In one embodiment, the second-tier service level enables the operator to access a second additional set of multi-media enhanced features.

Furthermore, a third-tier rate can be assessed for membership in a third-tier service level. In one embodiment, the third-tier service level enables the operator to access a third additional set of multi-media enhanced features. The third additional set of multi-media enhanced features can include, one or more of, a multi-player exercise session provided in real-time or near real-time, a team-based exercise session wherein the teams are user-specifiable, and/or advanced training support. The multi-player exercise session or the team-based exercise session may be VoIP-enabled

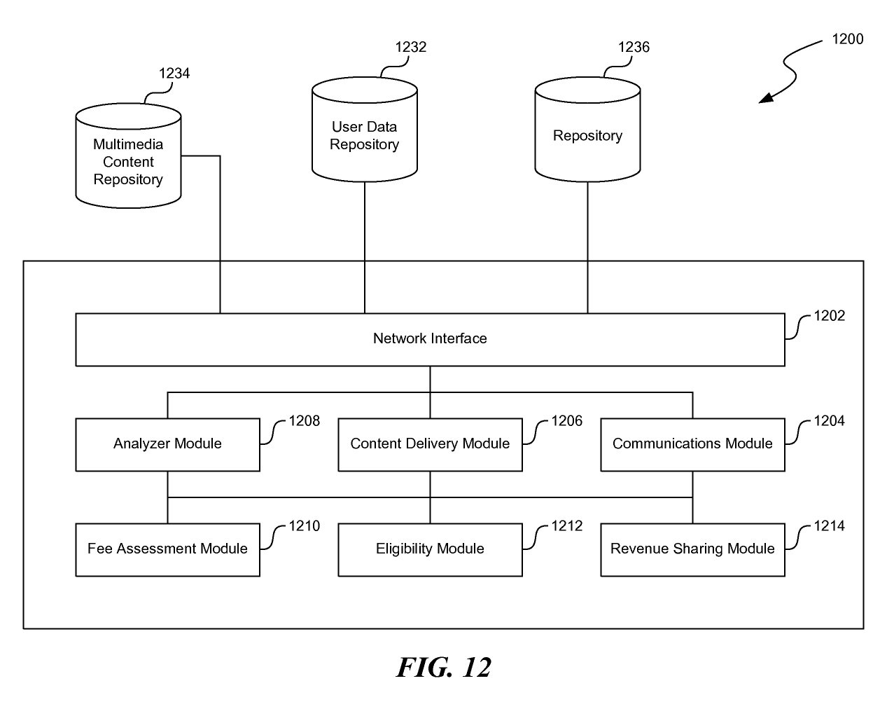

FIG. 12 depicts a block diagram of a host server 1200 that manages and facilitates revenue sharing with a fitness center, according to one embodiment.

The host server 1200 includes a network interface 1202, a communications module 1204, a content delivery module 1206, an analyzer module 1208, a fee assessment module 1210, an eligibility module 1212, and/or a revenue sharing module 1214. Additional or fewer modules can be included without deviating from the novel art of this disclosure. In addition, each module in the example of FIG. 12 can include any number and combination of sub-modules, and systems, implemented with any combination of hardware and/or software modules. The host server 1200 may be communicatively coupled to a user data repository 1232, a multimedia content repository 1234, and/or a repository 1236 as illustrated in FIG. 12. In some embodiments, the user data repository 1232, the multimedia content repository 1234, and/or the repository 1236 are partially or wholly internal to the host server 1200. The databases are described with further reference to FIG. 13A-C.

The host server 1200, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 12, the network interface 1202 can be one or more networking devices that enable the host server 1200 to mediate data in a network with an entity that is external to the host server, through any known and/or convenient communications protocol supported by the host and the external entity. The network interface 1202 can include one or more of a network adaptor card, a wireless network interface card, a router, an access point, a wireless router, a switch, a multilayer switch, a protocol converter, a gateway, a bridge, a bridge router, a hub, a digital media receiver, and/or a repeater.

A firewall, can, in some embodiments, be included to govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions performed or included in the functions of the firewall, can be, for example, but are not limited to, intrusion-prevention, intrusion detection, next-generation firewall, personal firewall, etc. without deviating from the novel art of this disclosure. In some embodiments, the functionalities of the network interface 1202 and the firewall are partially or wholly combined and the functions of which can be implemented in any combination of software and/or hardware, in part or in whole.

The network interface 1202 includes a communications module or a combination of communications modules communicatively coupled to the network interface 1202 to manage a one-way, two-way, and/or multi-way communication sessions over a plurality of communications protocols.

In the example of FIG. 2, the host server 200 includes the communications module 1204 or a combination of communications modules communicatively coupled to the network interface 1202 to manage a one-way, two-way, and/or multi-way communication sessions over a plurality of communications protocols.

Since the communications module 1204 is typically compatible of receiving and/or interpreting data originating from various communication protocols, the communications module 1204 is able to establish parallel and/or serial communication sessions with end users (e.g., end users of the internet and/or web-enabled exercise equipment), fitness centers, internet and/or web-enabled exercise equipment (e.g., also referred as an eligible-type of exercise equipment or a network-enabled exercise equipment) located at various locations. The communications module is also able to communicate with one or more of user data repository 1232, the multimedia content repository 1234, and/or the repository 1236.

Thus, in some embodiments, the communications module 1204 receives requests and inquiries from end users and fitness centers. The requests and/or inquiries may be placed via the exercise equipment or any internet and/or web-enabled device (e.g., PDA, Blackberry, iPhone, desktop computer, laptop computer, cell phone, etc.). In addition to requests and inquiries, the communications module also receives and/or processes exercise records, track records, health data, and/or other fitness data for users of the exercise equipment at various geographical locations.

Similarly, the communications module 1204 can transmit data to the end users via the exercise equipment or other internet, web-enabled devices, and/or communication devices. The data/information transmitted may be in various formats, including, but not limited to, multimedia content including, text, audio, speech, image, video, hypermedia, etc. For example, multi-media enhanced (e.g., video and audio) exercise environments are typically transmitted to exercise equipments and exercise data/fitness information can be provided to users automatically or upon request to exercise equipments or a internet and/or web-enabled device (e.g., portable device, cell phone, and/or computer).

One embodiment of the host server 1200 includes a content delivery module 1206. The content delivery module 1206 can be any combination of software agents and/or hardware modules able to manage, track, update, record, delivery of content, media, data to end users.

The content delivery module 1206 (hereinafter referred to as “delivery module”) is able to communicate with the multimedia content repository 1234 to retrieve multimedia content (e.g., music, video, text, speech, exercise instructions, fitness-related advice, and/or multimedia-enhanced exercise environments (virtual environment)) for delivery to end users via exercise equipment or any other internet and/or web-enabled device. For example, exercise instructions and/or other fitness related device can be provided to the user automatically or upon request, before, during, or after engaging in an exercise session on the exercise equipment.

In one embodiment, the content delivery module 1206 also controls and facilitates remote software/firmware upgrade of the internet and/or web-enabled exercise equipments. For example, software upgrades can be transmitted to exercise equipments upon request, periodically or as they become available. The settings may be configured by employees of the fitness center and/or modifiable by an operator (user).

In one embodiment, the delivery module 1206 manages content delivery to end users and exercise environments based on a membership status of the requesting user. The content that a particular user qualifies to receive may be determined based on the level of service that the particular user has signed up for. In general, the membership fee varies for each level and increases for service levels that offer additional sets of multimedia content or personalized/customized services. An example list of tiered service levels, associated offerings, and associated membership fees are illustrated with further reference to FIG. 5.

Therefore, the delivery module 1206 is generally able to determine the identity of a requesting user and thus determine the service level the user is registered for, if any. The delivery module 1206 thus manages the content (e.g., exercise environments, fitness data, coaching instructions, etc.) delivery to each user based on the identity and the service level. Generally, members of higher-tiered service levels are eligible to receive more exercise environments (e.g., more routes), increased personalized support (e.g., targeted messaging, performance feedback), and/or enhanced access to exercise/fitness data (e.g., fitness trends in tabular or graphical format for extended periods of time).

In one embodiment, the service level is automatically determined based on the hardware ID and/or the location of the equipment. For example, this feature can be used and/or activated on equipment located at one or more promotional sites.

One embodiment of the host server 1200 includes an analyzer module 1208. The analyzer module 1208 can be any combination of software agents and/or hardware modules able to process data, requests, information received from the end users via the exercise equipments or other internet and/or web-enabled devices.

In one embodiment, the analyzer module 1208, when in operation, communicates with the delivery module 1206 to facilitate control of content transmitted from the content delivery module 1206 to the exercise equipments. For example, the analyzer module 1208 can track users and their membership types and conveys the information with the delivery module 1206 to identify the content that can and cannot be delivered to a particular user.

One embodiment of the host server 1200 includes a fee assessment module 1210. The fee assessment module 1210 can be any combination of software agents and/or hardware modules able to request, assess, and/or process a fee from a member based on a subscription type.

The fee assessment module 1210 is, in one embodiment, communicatively coupled to the analyzer module and determines membership status of the users. Since different types of memberships (e.g., memberships span various tiered service levels) generally require different amounts of membership fees, the fee assessment module 1210 can determine the amount of fee to assess of a particular user based on their membership status.

The fee assessment module 1210 can generate a request for fee via internet and/or web-enabled exercise equipment or via any other internet and/or web-enabled device. The request can be generated at the time the user signs up for the services or at a later time at predetermined periods of time. For example, a fee may be due each month and the monthly dues may be assessed on or around the same date of each month. Alternatively, the request for payment may be sent via email, SMS, phone call, instant messaging, or during an exercise session. Payment dues may be requested via a website through which a user can manage his/her membership account and view exercise/fitness data. Example user interfaces of the website are illustrated with further reference to FIG. 6-8.

The fees can be assessed via any known and/or convenient manner including but is not limited to, cash, check, money order, credit card, direct deposit, automatic debit, etc. The fee assessment module 1210 is generally capable of offering members automatic payment capabilities where fees are automatically withdrawn or charged to a credit card at predetermined periods of time (e.g., per week, per month, per two months, etc.).

In one embodiment, the fee assessment module 1210 tracks the membership fee dues and collections generated from users that use the exercise equipments in various fitness centers. The total dues and collections generated from a fitness center can determine whether the fitness center is eligible for sharing the revenues generated from membership fees.

One embodiment of the host server 1200 includes an eligibility module 1212. The eligibility module 1212 can be any combination of software agents and/or hardware modules able to determine whether a fitness center is eligible for revenue sharing.

In one embodiment, the eligibility module 1212 is communicatively coupled to the fee assessment module 1210 to determine the revenue generated from membership fees for each participating fitness center. For example, the fitness center may be eligible when the revenue over a predetermined period exceeds a value. Eligibility is, in one embodiment, partially or wholly based on revenue generated from membership fees originating in the fitness center.

The eligibility module 1212 can also communicate with the repository 1236 to obtain any additional information about a participating fitness center to determine eligibility. For example, the repository 1236 may include information related to the number of eligible-type exercise equipments physically located in a particular fitness center. In one embodiment, eligibility of a fitness center for revenue sharing is partially or wholly based on the number of eligible-type of exercise equipment physically located in the fitness center (either operable or non-operable).

Additional eligibility standards are contemplated can be verified by the eligibility module 1212 without deviating from the novel art of this disclosure. Each standard can be evaluated independently or in conjunction with any number of additional standards to determine the eligibility of a fitness center for revenue sharing.

One embodiment of the host server 1200 includes a revenue sharing module 1214. The revenue sharing module 1214 can be any combination of software agents and/or hardware modules able to compute and/or process the revenue to be shared with a fitness center, for example, a fitness center that has been determined eligible.

In one embodiment, the revenue sharing module 1214 is communicatively coupled to the eligibility module 1212 to determine which fitness centers revenue is to be shared with. Eligibility is generally although not necessarily determined for each predetermined period of time (e.g., per week, per month, per quarter, per six months, etc.). For the eligible fitness centers, the revenue sharing module 1214 determines the amount of revenue to be shared and processes the payment. In one embodiment, the revenue is determined based on collected portion of the membership fee assessed from the service subscribers. The revenue shared with the fitness center is generally a predetermined percentage of the total revenue generated from the members that use the exercise equipments physically located in the fitness center. For example, the fitness center receives 35% of the total revenue generated from the fitness center.

FIG. 13A depicts a block diagram illustrating a repository 1334A for storing multimedia content, according to one embodiment.

In the example of FIG. 13A, the repository (e.g., a database) 1334A can store multimedia content. Content including but not limited to video content, audio content, textual content, hyper media content can be stored in repository 1334A. In one embodiment, the repository (e.g., a database) 1334A stores virtual exercise routes (e.g., exercise environments), audio files, and/or software/firmware upgrades. New exercise routes can be added periodically and existing exercise routes can be updated as necessary. Audio files can include coaching instructions, music, recommendations, fitness advice, that are pre-recorded, downloaded, or computer simulated/generated. An example list of multimedia content that can be stored in the repository 1334A is illustrated in 1334B.

FIG. 13B depicts a block diagram illustrating a repository 1332A for storing user data, according to one embodiment.

In the example of FIG. 13B, the repository (e.g., a database) 1332A can store user data. User data can include user profile information, exercise-related data, and/or fitness-related information. For example, the user profile information can include user name, age of user, gender, email address or other contact information, membership type, and/or member fee. Fitness information stored about a user may include by way of example but not limitation, maximum heart rate, minimum heart rate, average heart rate, total calories burned, distance rode (miles), average power (watts), etc.

FIG. 13C depicts a block diagram of a repository 1336A for storing fitness center data, according to one embodiment.

In the example of FIG. 13C, the repository (e.g., a database) 1336A can store fitness center data such as fitness center information and revenue information. Fitness center information typically includes but is not limited to, name of fitness club, location of club, number of clubs, number of eligible-type exercise equipments on-site, number of club members, number of users of the eligible-type exercise equipment, number of service subscribers. Revenue information can include, for example, monthly revenue from subscribers, monthly revenue from members, and/or yearly revenue from members.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other methods, devices, and/or systems, not necessarily to those described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the device may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated.

In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. Accordingly, the inventors reserve the right to add additional claims after filing the application to pursue such additional claim forms for other aspects of the disclosure.

What is claimed is:

1. A method to incentivize purchase of an internet and/or web-enabled exercise equipment by a fitness center, comprising:
assessing a fee from a user of the internet and/or web-enabled exercise equipment;
collecting at least a portion of the fee from the user; and
sharing the at least a portion of the fee with the fitness center where the internet and/or web-enabled exercise equipment is physically located.

2. The method of claim 1, wherein, the internet and/or web-enabled exercise equipment is purchased or leased by the fitness center.

3. The method of claim 1, wherein, the internet and/or web-enabled exercise equipment is associated with a unique ID.

4. The method of claim 1, wherein, a predetermined percentage of the at least a portion of the fee is shared with the fitness center.

5. The method of claim 1, further comprising, registering the user as a member of a tiered service level.

6. The method of claim 1, further comprising, providing different features via the internet and/or web-enabled exercise equipment based on the tiered service level for which the user is being assessed a fee.

7. The method of claim 3, wherein, the fitness center in which the internet and/or web-enabled exercise equipment is physically located is determined by the hardware ID.

8. The method of claim 3, wherein, the fitness center where the user operates the internet and/or web-enabled exercise equipment is determined by the hardware ID.

9. A method of sharing revenue with a fitness center, comprising:
optionally determining eligibility of a fitness center to share revenue generated from membership fee of a plurality of service subscribers;
wherein the membership fee is assessed from a service subscriber of the plurality of service subscribers to utilize web-features of an eligible-type of exercise equipment physically located in the fitness center;
in response to verifying eligibility of the fitness center, computing a portion of the revenue to be shared with the fitness center; and
sharing the portion of the revenue with the fitness center.

10. The method of claim 9, wherein, the eligibility is determined by an amount of revenue generated from the membership fee of the plurality of service subscribers.

11. The method of claim 10, wherein, the fitness center is eligible if the amount of revenue exceeds a predetermined value.

12. The method of claim 9, wherein, the eligibility is determined by a number of the eligible-type of exercise equipment operable for use at the fitness center; wherein the eligible-type of exercise equipment are purchased or leased.

13. The method of claim 12, wherein, the fitness center is eligible if the number of the eligible-type of exercise equipment exceeds a predetermined number.

14. The method of claim 9, wherein, the portion of the revenue to be shared with the fitness center is a predetermined percentage of the revenue.

15. The method of claim 9, wherein, the revenue is determined based on collected portion of the membership fee assessed from the plurality of service subscribers.

16. The method of claim 9, further comprising, registering the service subscriber as a member of a tiered service level based on an amount of the membership fee that is assessed.

17. The method of claim 16, further comprising, providing different web-based features via the eligible-type of exercise equipment based on the tiered service level that the service subscriber has enrolled in.

18. The method of claim 17, further comprising, offering a first set of web-based features to a zero-th tier service level service subscriber.

19. The method of claim 18, further comprising, further offering a first additional set of web-based features to a first-tier service level service subscriber.

20. The method of claim 19, further comprising, further offering a second additional set of web-based features to a second-tier service level service subscriber.

21. The method of claim 18, wherein, the offering of the first set of web-based features comprises, generating a report of exercise data of the zero-th tier service level service subscriber over a predetermined time period.

22. The method of claim 18, wherein, the first set of web-based features further comprises, generating a report of exercise data of the zero-th tier service level service subscriber over a predetermined time period.

23. The method of claim 22, wherein, the report is delivered to the zero-th tier service level service subscriber via email or in real-time.

24. The method of claim 22, wherein, the report is graphical.

25. The method of claim 22, wherein, the first set of web-based features further comprises, enabling the zero-th tier service level service subscriber to participate in contests or events.

26. The method of claim 22, wherein, the first set of web-based features further comprises, providing the zero-th tier service level service subscriber with performance benchmarking data.

27. The method of claim 22, wherein, the first set of web-based features further comprises, sending the zero-th tier service level service subscriber targeted advertisement and personalized messages.

28. The method of claim 19, wherein, the first additional set of web-based features comprises, a report of exercise data of the first tier service level service subscriber over an extended time period over the predetermined time period for the zero-th tier service level service subscriber.

29. The method of claim 28, wherein the first additional set of web-based features further comprises, providing demographic specific exercise data of service subscribers.

30. The method of claim 28, wherein, the first additional set of web-based features further comprises, enabling the first tier service level service subscriber to participate in additional contests or additional events.

31. The method of claim 28, wherein, the first additional set of web-based features further comprises, providing the first tier service level service subscriber with ghost riders.

32. The method of claim 28, wherein, the first additional set of web-based features further comprises, enabling the first tier service level service subscriber to personalize settings.

33. The method of claim 20, wherein, the second additional set of web-based features comprises, a multi-player racing session in real-time.

34. The method of claim 33, wherein, the second additional set of web-based features further comprises, a team racing session in real-time.

35. The method of claim 34, wherein the real-time session is VoIP-enabled.

36. The method of claim 33, wherein, the second additional set of web-based features further comprises, advanced training support.

37. A method of providing tiered service levels via a network-enabled exercise equipment, comprising:
providing a default set of features via the network-enabled exercise equipment, the default set of features comprising, multimedia content enhanced exercise environments; and
in response to determining identification of an operator of the network-enabled exercise equipment, providing a customized set of features, the customized set of features comprising, operator-specific performance feedback.

38. The method of claim 37, wherein, the identification of the operator is based on verifying an identifier submitted via the network-enabled exercise equipment.

39. The method of claim 38, wherein the identifier comprises a unique username and password combination for the operator.

40. The method of claim 37, wherein, the operator-specific performance feedback is delivered via the network-enabled exercise equipment.

41. The method of claim 37, wherein, the customized set of features further comprises, operator-specific messaging.

42. The method of claim 37, wherein, the customized set of features further comprises, targeted advertising.

43. The method of claim 37, further comprising:
in response to receiving a request from the operator to receive web-based exercise-related information, requesting the operator for an email address to which correspondences are to be sent;
storing the email address for the operator;
sending the web-based exercise-related information for the operator to the email address.

44. The method of claim 43, wherein, the web-based exercise-related information comprises, a report of exercise data generated by the operator over a predetermined time period.

45. The method of claim 43, further comprising, providing additional set of multi-media enhanced features.

46. The method of claim 43, wherein, the receiving the request is associated with receiving a membership request for a first-tier service level.

47. The method of claim 46, further comprising, assessing a first-tier rate for membership in the first-tier service level.

48. The method of claim 47, further comprising, assessing a second-tier rate for membership in a second-tier service level; wherein the second-tier service level enables the operator to access a second additional set of multi-media enhanced features.

49. The method of claim 48, further comprising, assessing a third-tier rate for membership in a third-tier service level; wherein the third-tier service level enables the operator to access a third additional set of multi-media enhanced features.

50. The method of claim 49, wherein, the third additional set of multi-media enhanced features comprises, one or more of:
a multi-player exercise session provided in real-time or near real-time;
a team-based exercise session wherein the teams are user-specifiable; and
advanced training support.

51. The method of claim 50, wherein, the multi-player exercise session or the team-based exercise session is VoIP-enabled.

52. The method of claim 37, further comprising, assigning the tiered service levels based on the location or hardware ID of the networked exercise equipment.

53. The method of claim 37, wherein, different networked exercise equipments are associated with various levels of the tiered service levels.

54. The method of claim 37, further comprising, providing a license for the networked exercise equipment that allows the operator of the exercise equipment to access a predetermined tiered service level.

55. A system, comprising:
a multimedia content repository to store multimedia content;
a communications module communicatively coupled to a plurality of eligible-type of exercise equipments physically located in one or more fitness centers;
a content delivery module coupled to the multimedia content repository module and the communications module;
an eligibility module coupled to the communications module, wherein, when, in operation, determines if the one or more fitness centers are eligible for revenue sharing;
a revenue sharing module.

56. The system of claim 55, wherein the media content comprises, multimedia enhanced virtual exercise environments.

57. The system of claim 55, further comprising, an analyzer module, communicatively coupled to the communications module and the content delivery module, wherein, when, in operation, processes data received from the plurality of eligible-type of exercise equipments.

58. The system of claim 57, wherein the analyzer module is further communicatively coupled to the content delivery module, wherein, when, in operation, controls content transmitted from the content delivery module to the plurality of eligible-type of exercise equipments.

59. The system of claim 55, further comprising, a repository to store information related to the one or more fitness centers having the plurality of eligible-type of exercise equipments.

60. The system of claim 55, further comprising, a user data repository to store membership information.

61. The system of claim 60, further comprising, a fee assessment module coupled to the user data repository, wherein, when, in operation, assesses membership fee of a plurality of service subscribers; wherein, the membership fee is assessed from a service subscriber of the plurality of service subscribers to utilize web-features of at least a portion of the plurality of eligible-type of exercise equipment physically located in the one or more fitness centers.

62. A method, comprising:
receiving a request to receive access to a feature via a networked exercise equipment, the request to be received based on an action performed by an operator of the networked exercise equipment;
identifying user information associated with the operator, the user information comprising billing information;
providing access to the feature via the networked exercise equipment; and
billing the operator for the feature using the billing information.

63. The method of claim 62, wherein, the action performed by the operator comprises a click of a button on the networked exercise equipment.

64. The method of claim 62, wherein, the request is received in real-time or near real-time by a server at a location remote from the networked exercise equipment.

65. The method of claim 62, wherein the request comprises, one or more of, a request to join a tournament, race, or contest.

66. The method of claim 62, wherein, the request comprises a request to purchase more digital objects.

67. A system to incentivize purchase of a internet and/or web-enabled exercise equipment by a fitness center, the system, comprising:
means for, assessing a fee from a user of the internet and/or web-enabled exercise equipment;
means for, collecting at least a portion of the fee from the user; and
means for, sharing the at least a portion of the fee with the fitness center.

68. A system to facilitate revenue sharing with a fitness center, the system, comprising:
means for, determining eligibility of a fitness center to share revenue generated from membership fee of a plurality of service subscribers;
wherein the membership fee is assessed from a service subscriber of the plurality of service subscribers to utilize web-features of an eligible-type of exercise equipment physically located in the fitness center;
means for, verifying eligibility of the fitness center;
means for, computing a portion of the revenue to be shared with the fitness center; and
means for, sharing the portion of the revenue with the fitness center.
